SEQUENCE LISTING (6 sequences)

SEQ ID NO: 1 - DNA, 24 bp, unknown
  just for example
gtaacggtagaataccgttgtcag

SEQ ID NO: 2 - DNA, 10 bp, unknown
  just for example
acgtccattg

SEQ ID NO: 3 - DNA, 22 bp, unknown
  just for example
gtaccgatgcatgctaacggtc

SEQ ID NO: 4 - DNA, 20 bp, unknown
  just for example
gtacagatgcaggctcacgg

SEQ ID NO: 5 - DNA, 23 bp, unknown
  just for example
atgcgttacgccatagcaacttg

SEQ ID NO: 6 - DNA, 18 bp, unknown
  just for example
atgcgttgccatagcaac

(19) United States
(12) Patent Application Publication
(10) Pub. No.: US 2016/0259886 A1
(43) Pub. Date: Sep. 8, 2016

(54) METHOD AND SYSTEM OF MAPPING SEQUENCING READS

(71) Applicant: ACADEMY OF MATHEMATICS AND SYSTEM SCIENCE, CHINESE ACADEMY OF SCIENCES, Beijing (CN)

(72) Inventors: Lei Li, Beijing (CN); Anqi Wang, Beijing (CN); Shijian Chen, Beijing (CN)

(21) Appl. No.: 14/901,645

(22) PCT Filed: Jun. 25, 2014
(86) PCT No.: PCT/CN2014/000621

§ 371 Date: Dec. 28, 2015

(30) Foreign Application Priority Data
Jul. 5, 2013 (CN) 201310282312.1

(51) Int. Cl. G06F 19/22; G06F 17/30

(52) U.S. Cl. CPC G06F 19/22; G06F 17/30324

(57) ABSTRACT

A method and a parallel-computing system of mapping sequencing reads is provided. The method preprocesses a reference genome to construct a compression structure of the reference genome, an index array and a block address array; the index array stores the index values of all sorted subsequences on the reference genome; the block address array stores the positions of a portion of the elements in the index array; the parameters involved in the mapping method are selected based on the statistical characteristics of the reference genome, the statistical quality information of sequencing reads and the polymorphism rates of the target species from which the sequencing reads are generated. Based on the structures constructed in the preprocessing stage, each sequencing read is mapped to the reference genome by anchoring on the genome by a certain single perfect match prefix seed, alignment extension based on the auto-match function method, and statistical assessment.

### TECHNICAL FIELD

The present invention is applicable to the technical field of DNA sequencing, in particular related to a method and system of fast mapping of high throughput sequencing reads and related quantitative analysis.

### BACKGROUND ART

High throughput DNA sequencing is the key technology for implementing personalized medicine and carrying out modern molecular biology research. In personalized medicine, high throughput DNA sequencing can obtain qualitative and quantitative information of the whole genome, transcriptome and various regulatory molecules of a person. It can comprehensively utilize polymorphisms and genetic mutation information of genomic sequences, expression information of functional genomics to implement disease diagnosis, disease risk prediction, etc. at the molecular level, thereby performing better treatment or prevention. In particular, the effect of a drug on an individual can be predicted quantitatively or qualitatively based on the individual's genomic sequence and functional genome information, thereby an optimal therapeutic regimen can be designed.

Besides human health, developments of agriculture, environment protection, energy sources, etc., which are of great concern for the human, are inevitably linked to our overall understanding about biology at the molecular level. One major technique adopted in molecular biology research is DNA sequencing.

When sequencing a genome, the genome is cut into many small fragments, and the base composition of these fragments (sequencing reads) are obtained through amplification, base-calling and other steps. Nevertheless, after the genome is cut, relative positions of various sequencing reads are still unknown. If no reference genome exists, the genome under sequencing can only be reconstructed through assembly technology. However, if a genome which has already been sequenced can be taken as a reference, the reconstruction of genome turns to be a problem of re-sequencing, which is relatively easier. For the moment, most of sequencing problems in biology research and personalized medicine are or can be approximately converted into a re-sequencing problem. In re-sequencing, the procedure of finding the position or coordinate of each sequencing read on the reference genome is called as sequencing reads mapping.

Several major types of molecular biology information that can be measured through DNA re-sequencing are listed below.

DNA polymorphism—sequencing reads sampled from a certain genome are compared with reference genome reads to investigate single nucleotide polymorphism (SNP) and insertion or deletion polymorphism between two genomes;

Methylation—Methylated sites on the genome being sequenced are investigated through mapping sequencing reads to the reference genome;

mRNA expression profile—abundance of different kinds of RNA are measured through mapping the sequencing reads of the transcriptome to the reference genome;

Alternative splicing—mRNA alternative splicing isoforms are investigated by mapping sequencing reads of transcriptome to the reference genome;

Non-coding RNA abundance—abundance of different kinds of non-coding RNA (such as microRNA and lncRNAs) are measured through mapping sequencing reads of transcriptome to the reference genome;

ChIP-seq—DNA fragments combined by the proteins of interest are specifically enriched through Chromatin Immunoprecipitation (ChIP), and high throughput sequencing data of these DNA fragments is mapped to the reference genome so as to obtain the segments on a genome that interact with histones or transcription factors.

DNA re-sequencing is widely used, not restricted to the above listed aspects. Accordingly, the mapping of sequencing reads becomes a routine and indispensable in personalized medicine and the research of molecular biology. Sequencing reads mapping is the procedure of anchoring sequencing reads given by a sequencing platform to a reference genome. Although the concept of mapping is clear, the high-throughput next generation sequencing technology can generate a great deal of sequencing reads within a short time, and how to use a relatively universal computer facility to complete the mapping work at a high speed is an extremely challenging problem in computational biology.

Besides mapping speed, accurate evaluation of mapping rate and accuracy of a mapping method and system are the foundation for downstream analysis. The mapping rate refers to the proportion of the reads that can be mapped to the reference genome, while the accuracy refers to the proportion of the reads that are mapped to the correct positions in the successfully mapped reads. The mapping rate and accuracy are sometimes replaced by another pair of indices, sensitivity and specificity. In many cases, owing to technology limitation, sensitivity and specificity cannot be improved at the same time, and how to achieve a balance between sensitivity and specificity is also an extremely challenging problem.

Sequencing reads mapping is the procedure of anchoring the sequencing reads given by the sequencing platform onto the reference genome. Since sequencing reads mapping plays an important role in the process of next generation sequencing data analysis, people have developed many mapping tools which adopt the method of simultaneously mapping multiple seeds (seed is an alternative name of the subsequence on the sequencing read), that is to say, multiple seeds are used at the same time to anchor a sequencing read on the reference genome. In some methods thereof, several mismatches are also allowed in the seed so as to improve accuracy of mapping. However, such methods require large memory, and the seed used for anchoring has limited length; in addition, the complexity of the algorithm is increasing when more mismatches are allowed. Owing to the limited length of sequencing reads generated by previous sequencing technology, the above method is reasonable. Whereas, with the development of next generation sequencing, read length has increased from the initial 20 bases to hundreds of bases at present. In this way, the mapping methods which use multiple seeds are not applicable. Moreover, allowing for mismatches in the seeds will reduce the mapping speed. Therefore, the mapping efficiency of the above methods cannot satisfy our requirement. Meanwhile, in order to find INDELs, all the existing mapping tools use dynamic programming algorithm (Smith-Waterman algorithm or its variants). However, with respect to the increase of read length, time complexity and space complexity of dynamic programming algorithm will increase at quadratic level. Therefore, the existing mapping algorithms can hardly be applied to map the next generation sequencing data.

Owing to the computational complexity of the existing methods, it is required to adopt cluster computer for mapping. However, even if cluster computer is adopted, the mapping procedure will still take several days on large datasets. The costs for computer maintenance will be reduced tremendously if a mapping tool can be developed that has a fast mapping speed and a high accuracy, and can complete all mapping works on a small workstation.

Furthermore, statistical analysis for mapping sequencing reads is important to the research works that are based on next generation sequencing data. However, at present, except that MAQ, a read mapping tool, provides simple statistical analysis, all other mapping tools lack parameter design criteria and evaluations for mapping rate and accuracy rate.

Interpretation about following related terms:

Next Generation Sequencing: Next generation sequencing (hereafter referred to as NGS) utilizes several biological chemistry technologies to cut the measured genome into a large amount of fragments and call the base composition of each sequencing read, the characteristic of which is to generate high-throughput sequencing reads data in a parallel way.

Sequencing read: Output of a sequencing platform after a certain living organism genome is sequenced, and it is composed of several nucleotide letters (A, C, G and T) representing four kinds of bases and represents one fragment on the genome being sequenced.

bp: Abbreviation of “base-pair”; read of 100-bp means that one DNA read has 100 bases.

Miscalling: Owing to sequencing technology error, some bases in sequencing reads are different from true bases.

Quality value: During the sequencing procedure, each base on the sequencing reads is possible to be miscalled and quality value reflects the possibility of miscalling. Each base on the sequencing reads is assigned a quality value. The higher the quality value is, the lower the miscalling rate is.

Reference genome: A genome from the same or closed species to which the sequenced living organism belongs; the genome has already been sequenced.

Mapping of sequencing reads: Process of finding the position or coordinate of the sequencing reads on the reference genome.

n-mer: A subsequence on the reference genome or a sequencing read whose length is n.

Perfect match prefix seed: A prefix of a subsequence on the sequencing read which is identical to, or perfect match to some equal-length subsequences on the reference genome. The subsequence on the sequencing read is used to initially anchor the sequencing read on the reference genome.

Base substitution: After a sequencing read is mapped to the reference genome, certain bases are different from the corresponding bases on the reference genome.

Insertion: Compared with the reference genome, some continuous bases are inserted between two adjacent bases on the sequencing read.

Deletion: Compared with the reference genome, the sequencing read loses some continuous bases.

INDEL: an insertion or deletion.

Numerical value: The integer value obtained after a base sequence is encoded. If A, C, G and T are respectively encoded by the two-digits 00, 01, 10, 11, the numerical value of read ATGCTA is 001110011100.

Index value: The start point of a subsequence on the reference genome. If the reference genome is ATGTAGCTA, then the index value of the subsequence ATGTA is 0, and the index value of the subsequence AGCTA is 4. The 4-mer with index value 2 is GTAG, and the 3-mer with index value 6 is CTA.

### SUMMARY OF THE INVENTION

Aiming at solving the problems existed in prior art, the present invention provides a high throughput data mapping system for next generation sequencing based on three truths (1), (2) and (3) below to increase the mapping speed and to perform statistical analysis for mapping accuracy:

(1) With the development of next generation sequencing technology in recent years, the read length becomes longer than before, namely it can be 100-bp or longer, and the base-calling error rate is declining at the same time. For example, in Illumina sequencing technology, the errors are basically miscalling, and INDELs rarely occur in sequencing;

(2) Regarding conserved genome, such as human genome, the possibility of occurring two or more INDELs within 100-bp is less than 0.01%, while the average length of each INDEL is only 3;

(3) Memory for scientific computer is increased substantially. Therefore, it is feasible to pursue efficiency at the cost of more memory space.

Based on the above three points, the present invention provides a method of mapping sequencing reads, which operates on a reference genome and at least one sequencing read, wherein the reference genome is a genome which has already been sequenced. The mapping comprises the following steps:

Step 1: performing preprocessing for the said reference genome to generate a compression structure of the reference genome, an index array and a block address array; wherein the said reference genome compression structure stores the whole reference genome in a compressive way; the said index array stores the index values of all sorted n-mers on the said reference genome; and the said block address array is configured to store the positions of a portion of elements in the index array, aiming at accelerating the anchoring of a sequencing read on the reference genome;

Step 2: based on the characteristics of a reference genome, the information of all the sequencing reads as a whole, genetic differences between the reference genome and the species from which the sequencing reads are generated, designing the parameters of a mapping algorithm according to probability calculation to meet or compromise the requirements on sensitivity, specificity and mapping speed;

Step 3: based on the above said reference genome compression structure, index array and block address array obtained through preprocessing, mapping each sequencing read to the said reference genome through the steps of seed anchoring, extension based on auto-match function method and statistical analysis;

Step 4: outputting the mapping information of each sequencing read.

The present invention also provides a system of mapping sequencing reads, which operates on a reference genome and at least one sequencing read; wherein the reference genome is a genome which has already been sequenced; and the system comprises:

a reference genome preprocessing module, which is configured to perform preprocessing for the said reference genome to generate a reference genome compression structure, an index array and a block address array; wherein the said reference genome compression structure stores the whole reference genome in a compressive way; the said index array stores the index values of all sorted n-mers on the said reference genome; and the said block address array is configured to store the positions of a portion of elements in the index array, aiming at accelerating the anchoring of a sequencing read on the reference genome;

a parameter design module, which is configured to design a mapping algorithm parameters according to probability calculation, based on the characteristics of the reference genome, the information of all the sequencing reads as a whole, genetic differences between the reference genome and the species from which the sequencing reads are generated, to meet or compromise the requirements on sensitivity, specificity and mapping speed;

a mapping module, which is configured to map each sequencing read to the said reference genome through the steps of seed anchoring, extension based on the auto-match function method, and statistical analysis, based on the above said reference genome compression structure, index array and block address array obtained through preprocessing;

a result outputting module, which is configured to output the mapping information of each sequencing read.

After mapping and statistical analysis, the above plan presented in the present invention outputs whether each sequencing read is successfully mapped, positions of the successfully mapped sequencing reads on the reference genome, and alignment information between the sequencing reads and the reference genome, etc. Before mapping the sequencing reads, the present invention shall preprocess the input reference genome. Afterwards, by using the same method, the present invention completes the mapping and statistical analysis for each sequencing read in a parallel way based on the structures obtained through preprocessing.

### DESCRIPTION OF THE FIGURES

FIG. 1 is an overall flow chart for a method of mapping sequencing reads in the present invention;

FIG. 2 is the scatter plot of the sorted numerical values of all 32-mers of the human genome, obtained by respectively encoding A, C, G and T as 00, 01, 10, 11 versus the quantiles of a uniform distribution; wherein, the vertical axis shows each numerical value and the horizontal axis shows equant values of uniform distribution;

FIG. 3 is an illustration of the index array definition used in the preprocessing of the reference genome in the present invention;

FIG. 4 is an illustration of a method that uses 16-digit unsigned binary numbers to store 20-digit binary index values in the present invention;

FIG. 5 is an illustration of a method that uses 16-digit unsigned binary numbers to store 28-digit binary index values in the present invention;

FIG. 6 is an illustration of constructing a block address array in the present invention;

FIG. 7 is a detailed flow chart of the method of mapping sequencing reads in the present invention;

FIG. 8 is an illustration of a method for restricting search area using a block address array in the present invention;

FIG. 9 is an illustration of a procedure for adopting binary search to perform anchoring for an n-mer on a sequencing read in the present invention;

FIG. 10 is an illustration of the definition of the match vector in the present invention;

FIG. 11 is an illustration for detecting an INDEL length using auto-match function method in the present invention;

FIG. 12 is an illustration for detecting starting position of an INDEL in the present invention; and

FIG. 13 is an illustration of an alternative method for detecting an INDEL length and its starting position.

### EMBODIMENTS

In order to guarantee that purpose, technical scheme and advantages of the present invention are more clear and specific, the present invention are further described in detail in the following with reference to the accompanying figures and specific embodiments.

The present invention provides a method of the fast mapping of the high throughput sequencing reads.

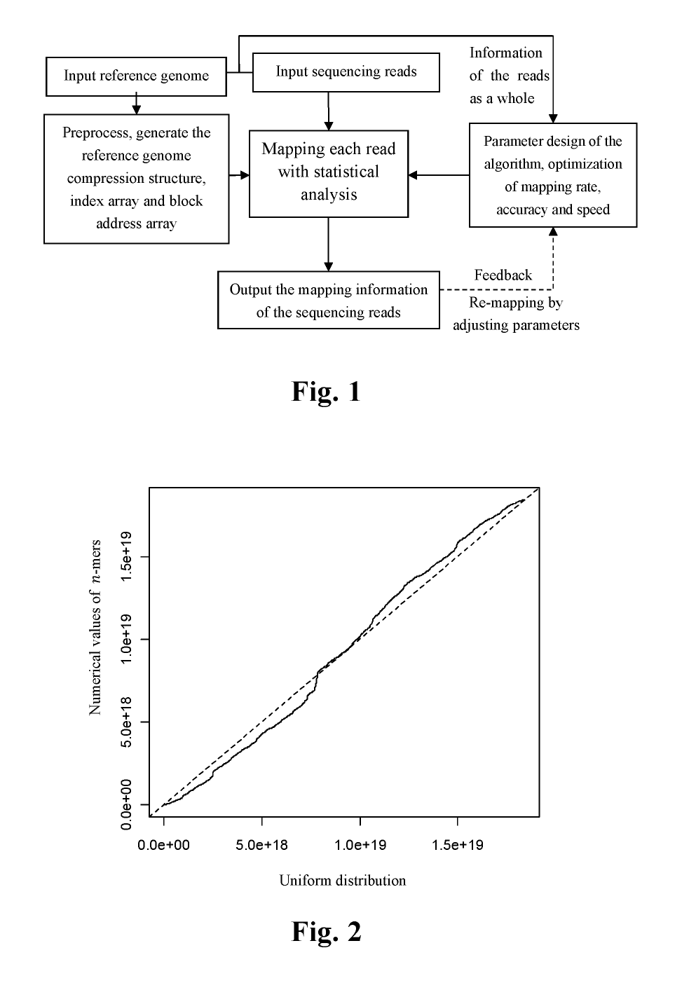

FIG. 1 shows an overall flow chart for the method of the fast mapping of the high throughput sequencing reads presented in the present invention.

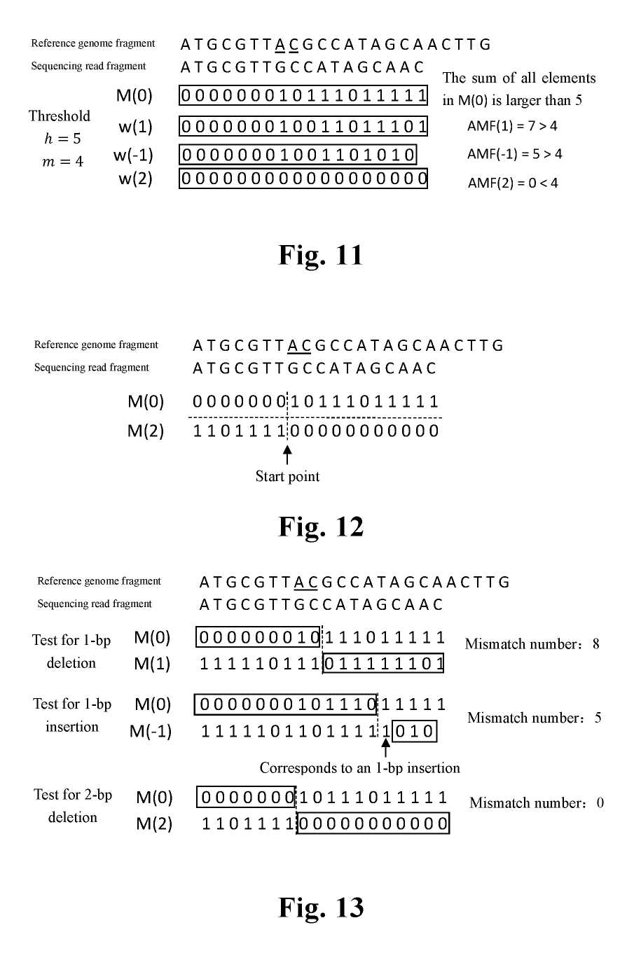

The input of the method comprises a reference genome and a read data set given by the sequencing platform, which contains one or more sequencing reads. The said reference genome and sequencing reads are composed of nucleotide letters (A, C, G and T) representing the four bases; the reference genome can be the genome of any species which has already been sequenced; the said sequencing reads and reference genome shall be generated from the same species or closed species. The said sequencing reads can contain the quality values which indicate the mis-calling rate for each base. The input sequencing reads may have different lengths. As is shown in FIG. 11, the method includes the following steps:

Step 1, a step of preprocessing the said reference genome.

At first, four bases A, C, G and T are encoded using a certain arrangement of two-digits 00, 01, 10 and 11. Encoding rules can be selected arbitrarily or through more meticulous analysis. Afterwards, three structures, i.e. reference genome compression structure, index array and block address array are established. Where, the said reference genome compression structure is configured to store the two-digits of reference genome sequence, with four bases being stored in each byte. The said reference genome compression structure is used for searching the subsequence that starts from given position on the reference genome, or the numerical value of the subsequence. The said index array stores the index value of each n-mer on the reference genome in a certain order. The said certain order is an order of the numerical value of the said each n-mer and is generated as below: after sorting the numerical values of all n-mers on the reference genome in ascending order, store their indices on the reference genome into a vector. The said block address array is configured to store positions of a portion of elements in the index array, aiming at accelerating the seed anchoring of sequencing reads on the reference genome. Given reference genome, the preprocessing can be performed only once and the result is kept in a storage system, which can be repeatedly used for different data sets of sequencing reads.

Step 2, a step of parameter designing.

Based on characteristics of genome, information of sequencing reads as a whole, the genetic differences between the reference genome and the species from which the sequencing reads are generated, the parameters used in mapping algorithm are designed according to probability calculation to meet or compromise the requirement on sensitivity, specificity and mapping speed. Wherein, the information of the said sequencing reads contains the distribution of lengths and base-calling quality values; the genetic differences between the reference genome and the species genome from which the said sequencing reads are generated contains SNP, frequency of INDEL occurring and INDEL length distribution. In all parameters, lower bound of perfect match prefix seed length k₀, as a major parameter, depends on the length, base composition rate and polymorphism rate of reference genome, and the lengths and quality values of sequencing reads. In step 1, the parameter n used for constructing the index array must be greater than k₀.

Step 3, a step of mapping.

Based on the said reference genome compression structure, index array and block address array obtained through preprocessing, or only based on two structures (i.e. the reference genome compression structure and index array), each given sequencing read is mapped, namely, searching the position of the said each sequencing read on the reference genome; three specific sub-steps are included: “seed anchoring”, “extension based on the auto-match function method” and “statistical analysis”.

Sub-step for seed anchoring: scanning the n-mers on the sequencing read sequentially based on a set order until finding a certain n-mer, which has a prefix with length greater than k₀ that can perfectly matches a subsequence on the reference genome. The index of the subsequence on the reference genome is served as the seed anchoring of the sequencing read.

Sub-step for extension based on auto-match function method: applying the auto-match function method newly presented in the present invention to divide the difference between a sequencing read and a reference genome into three cases: (1) only base substitutions exist; (2) only one INDEL exist at one side of the perfect match prefix seed; and (3) more than one INDEL exist at one side of the perfect match prefix seed. For (2), the auto-match function method is further used to detect the type, position and length of INDEL. For (3), the detailed difference is detected through alignment algorithm. In particular, local versus global alignment algorithm is adopted to detect the detailed difference between extended fragment (global) on the sequencing read and corresponding DNA fragment (local) on the reference genome. On average, the method has linear time complexity with respect to sequencing read length.

Sub-step for statistical analysis: for the fragments beyond the perfect match prefix seed on the sequencing read, set a “soft count” for the match status between each base and the corresponding base on the reference genome using the polymorphism rate of the species and the base-calling quality value, and carry on evaluation using probability distribution to determine whether it is necessary to re-map the sequencing read using a new n-mer.

Step 4, a step of feedback.

After a round of mapping for all sequencing reads, sequencing reads that are not successfully mapped or have poor sensitivity and specificity shall be re-mapped by adjusting the mapping parameters; wherein, the mapping parameters include all or a portion of parameters designed in step 2.

Step 5, a step of output.

Output the mapping information of each sequencing read by writing them into files with standard format.

The above method of mapping sequencing reads is applicable to qualitative or quantitative measurement of DNA hereditary information and RNA functional information in biological analysis and personalized medicine, including DNA polymorphism, methylation, messenger RNA expression profile, non-coding RNA abundance, ChIP-seq, alternative splicing and other information. At the same time, the above method of mapping sequencing reads is also applicable to genome assembly based on mapping.

The method presented in the present invention is described in detail below. At first, a method of mapping non-methylation sequencing reads is described in detail. For the mapping of methylation sequencing reads, only a part of steps need to be modified and the other steps remain the same. The specific differentiation is described in detail below.

In step 1 of the above method presented in the present invention, three structures used in mapping, including the reference genome compression structure, index array, and block address array, are generated in preprocessing stage. Step 1 specifically includes the following contents:

Step 11, constructing the reference genome compression structure. The reference genome compression structure stores the reference genome in a compressive way. It is used for searching a subsequence that starts from given position on the reference genome, or the numerical value of a subsequence. The constructing thereof contains the following steps:

Step 111: setting length n of each encoded subsequence, and n is a positive integer (preferentially setting the range thereof as 5≦n≦32). Performing the following operations for each encoding between nucleotide letter set {A, C, G, T} and two-digit set {00, 01, 10, 11}:

(1) For each n-mer on the reference genome, substitute the nucleotide letters A, C, G and T as the corresponding two-digit according to the given encoding, and obtain a binary code string in 2n length. This binary code string represents a binary integer value which is the numerical value of the n-mer; wherein, for each base on the reference genome, it is required to take out n-mer with the base as the start point. Furthermore, the seed having only one different base belong to a different n-mer;

The said n-mer is a subsequence with a length of n on the reference genome; the said encoding is one of the 24 one-to-one correspondence between the nucleotide letter set {A, C, G, T} and the two-digit set {00, 01, 10, 11}; the present invention encodes each n-mer on the reference genome according to the 24 one-to-one correspondence and obtains the numerical values of n-mers under each encoding.

(2) All numerical values are sorted in the ascending order.

Step 112: each sorted numerical value array is compared with the uniform distribution in [0, 4n], and the encoding corresponding to the array which is closest to the uniform distribution is taken as the encoding rule; namely, among all the numerical value arrays obtained in step 111, find the one which fits the uniform distribution in [0, 4ⁿ] best, and the encoding corresponding to this numerical value array is taken as final encoding rule;

FIG. 2 shows the relation between the sorted numerical values and uniform distribution, which are obtained by taking n as 32 in human genome and respectively encoding A, C, G and T as 00, 01, 10 and 11. In the figure, the vertical axis represents the numerical value and the horizontal axis represents the equant value of the uniform distribution.

Step 113: according to the encoding rule determined in step 112, using two-digits to store the reference genome base by base into a vector of the byte type, either in the left to right direction or in the right to left direction, with each byte storing four bases;

Step 12, construct the index array.

The index array stores the index values of all n-mers on the reference genome based on a certain order. It is used for the seed anchoring of the sequencing read onto the reference genome. Wherein, the said n-mer is a subsequence with a length of n on the reference genome, and n is the length that is set when constructing the reference genome compression structure. The construction thereof contains the following steps:

Step 121: among the numerical value arrays obtained in 111 (1), select the array corresponding to the encoding rule determined in step 112. Associate each numerical value with the index value of the corresponding n-mer on the reference genome. The numerical value of the n-mer and its index value on the reference genome jointly form an associated unit.

Step 122: all associated units are sorted in an ascending order based on the numerical values. The associated units with same numerical value are sorted in the ascending order based on the index values;

Step 123: based on length of the reference genome, one or several unsigned 16-digit, 32-digit or 64-digit integers are selected for storing all index values in the sorted associated units. Memory space occupied by these unsigned integers forms the index array.

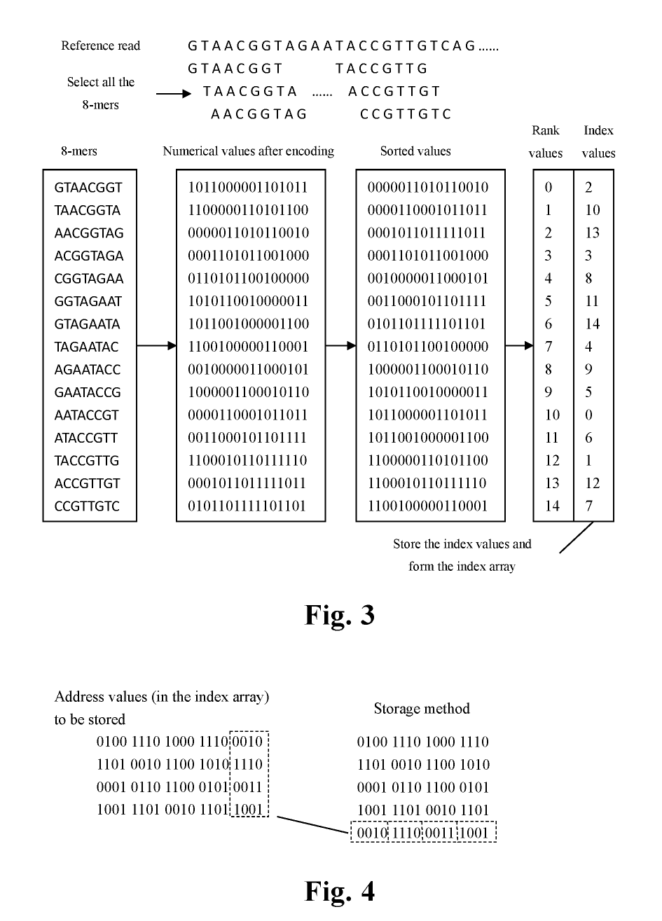

FIG. 3 shows the operations of constructing the index array by performing preprocessing on the reference genome in the present invention. With n=8 as an example, the operations of 8-mer selection, encoding and index array constructing are shown in FIG. 3. Wherein, the column of “Rank values” records the positions of the sorted elements in the index array. A, C, G and T are encoded as 00, 01, 10 and 11 respectively.

In step 122, all associated units can also be sorted in a descending order based on the numerical values. Associated units with same numerical value are sorted in a descending order based on the index values; the index array mentioned in the text below are all generated based on the ascending sorting method. If the index array is generated based on the descending sorting method, the mapping method is similar.

In step 123, preferentially, the index values can be stored in the following modes, wherein, b is the least integer no smaller than log₂N, and N is the length of the reference genome.

For the cases (1) to (3) stated below, 16-digit unsigned binary numbers are selected for storage; for cases (4) and (5), 32-digit unsigned binary numbers are selected for storage;

(1) When b≦16, each index value is sequentially assigned to each 16-digit unsigned binary number;

(2) When 16<b≦24, setting

$$c = ⌊ \frac{16}{b - 16} ⌋ ,$$

each c+1 binary numbers store c index values. Wherein, the former c binary numbers store the former 16 digits of each index value. The (c+1)-th binary number stores latter (b−16) digits of all the c index values;

$$⌊ \frac{16}{b - 16} ⌋$$

is the biggest integer no larger than

$$\frac{16}{b - 16} ;$$

FIG. 4 shows a method for storing the index values using 16-digit unsigned binary numbers when b=20. As is shown in FIG. 4, the left is the index values to be stored, while the right is the storage method: the former four 16-digit unsigned binary numbers respectively store the former 16 digits of the four index values, and the last 16-digit unsigned binary number stores the latter four digits of the four index values; the last 16-digit unsigned binary number can be stored separately from the former four 16-digit unsigned binary numbers.

(3) When 24<b≦28, setting

$$c = ⌊ \frac{16}{b - 24} ⌋ ,$$

each

$$( c + ⌈ \frac{c}{2} ⌉ + 1 )$$

binary numbers store c index values. Wherein, the former c binary numbers sequentially store the former 16 digits of each index value; the

$$⌈ \frac{c}{2} ]$$

binary numbers hereafter store a pair of 8 digits that start from the 17^{th} digit on each two index values; the last binary number store latter (b−24) digits of all the c index values;

$$⌈ \frac{c}{2} ]$$

is the least integer no smaller than

$$\frac{c}{2} ;$$

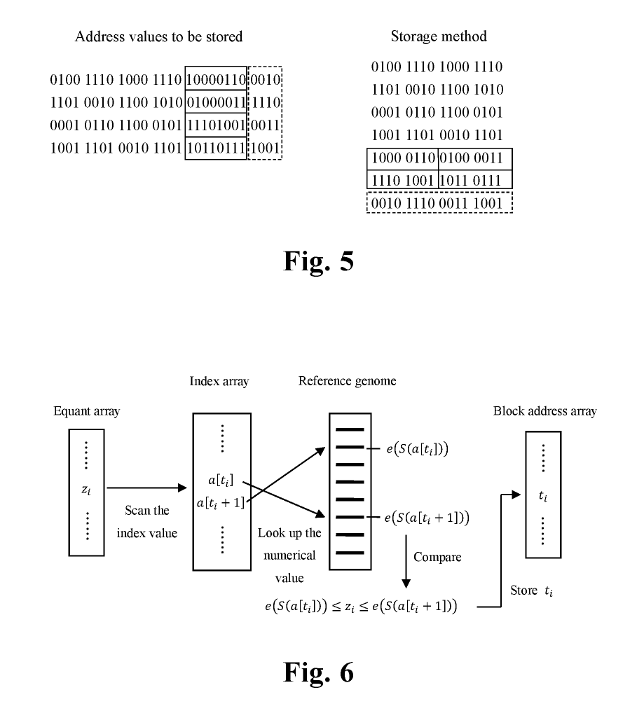

FIG. 5 shows an illustration for storing the index values using 16-digit unsigned binary numbers when b=28, wherein each seven 16-digit unsigned binary numbers store 4 index values.

(4) When 28<b≦31, setting

$$c = ⌈ \frac{b}{32 - b} ⌉ ;$$

each c binary numbers store (c+1) index values. The former c index values are sequentially stored in the former b digits of the c binary numbers; the (c+1)-th index value is stored in the remaining (32−b)c bits;

(5) When b=32, 32-digit unsigned binary numbers are used to store the index values; the index values are sequentially assigned to each a-digit unsigned binary number;

(6) When b>32, the index values are stored in several groups. At most 2³² integers are stored in each group. Divide the index values in each group by 2³², and store the remainders using the binary numbers with proper digits according to the methods described from (1) to (5).

For case (4) above, unsigned 32-digit integers can be used for storing the index values; for case (6), unsigned 64-digit integers can be used for storing the index values.

In order to clearly introduce the mapping steps, some necessary marks are introduced. The j^{th} element stored in the index array is marked as a[j]. During execution, the value of a[j] can be obtained from the index array with word bit operation according to storage method of step 123. The subsequence with a length of n and index value as a[j] (i.e. starting from the a[j]-th base) on reference genome is marked as S(a[j],n). S(a[j],n) is called as the n-mer corresponding to index value a[j] or as the n-mer starting from the index value a[j] on the reference genome. After S(a[j], n) is encoded based on the encoding rule determined in step 112, the obtained numerical value is marked as e(S(a[j],n)). During execution, given the value of a[j], the numerical value e(S(a[j],n)) can be obtained from the reference genome compression structure using word bit operation according to the storage method in step 113.

Step 13, block address array is constructed. The block address array is configured to accelerate the seed anchoring. In some occasions, for example, the numerical value array obtained through encoding and sorting has large deviation from the uniform distribution, this structure may not be used during mapping. The construction thereof includes following steps:

Step 131: a one-dimensional array is established to store the uniformly distributed equant zᵢ=i×2^{2n-c}, i=0, 1, 2, . . . , 2^{c}−1 of the interval [0, 4ⁿ−1] in ascending order, and wherein n is the length of the encoded subsequence set in step 111, and c(1≦c≦2n) is a predetermined integer value which decreases the visit times of the index array when anchoring each n-mer by c on average; if the memory is larger enough and 1≦½ log₂N≦2n, c can be preferentially set as the largest integer no greater than ½ log₂N or the least integer no smaller than ½ log₂N. Wherein, N is the length of the reference genome.

Step 132: for each equant zᵢ obtained in step 131, binary search is used to find two adjacent elements a[tᵢ] and a[tᵢ+1] in the index array so that equant zᵢ is between the numerical values e(S(a[tᵢ],n)) and e(S(a[tᵢ+1]),n), namely e(S(a[tᵢ],n))<zᵢ<e(S(a[tᵢ+1]), n). The value tᵢ of index value is recorded so as to correspond to the equant zᵢ, namely, the value tᵢ is recorded as the i^{th} value of the block address array; if at least one index values can be found with the numerical values of the corresponding n-mers being exactly equal to zᵢ, then let tᵢ be the smallest rank of these elements in the index array so as to correspond to the equant zᵢ, and store ti as the i^{th} value of the block address array.

Step 133: the value tᵢ recorded directing to each equant zᵢ in step 132 is stored in an array: q[i], i=0, 1, 2, . . . , 2^{c}; before mapping sequencing reads, the array q[i] is put into the memory at first.

FIG. 6 shows an illustration for the construction of the block address array in the present invention. As is shown in FIG. 6, the value of equant zᵢ is between e(S(a[tᵢ],n)) and e(S(a[tᵢ+1], n)), and tᵢ is stored as the i^{th} value of the block address array.

The parameter design in step 2 of the mapping method is described in detail below. Parameters in algorithm include:
The length of the encoded subsequence n in step 111 during preprocessing;
k₀, the lower bound of the longest prefix length on each n-mer from the sequencing read, wherein the prefix is perfect match with a equal-length subsequence on the reference genome. k₀ is a key parameter, by which mapping sensitivity and specificity are mainly determined, and it shall be smaller than n.
G, the maximal number of places on the reference genome that a perfect match prefix seed is allowed to be anchored; it is a parameter required when processing the reads associated to the homologous regions on the genome, and it is determined by the genomic characteristics of related species. For human genome, G can be selected as 3, 5, etc.
The upper bound value U of the numbers of n-mer search, and the bigger the parameter is, the closer the algorithm becomes to the searching plan of all n-mers while the lower the speed is.
Maximal value B of detectable INDEL length, and it is determined according to the population genetics characteristics of the related species. For human genome, 5, etc. can be selected.
Test level α in statistical analysis; the sensitivity and specificity are partially determined by this parameter.

Parameters to be designed are mainly k₀, α and U. Furthermore, the algorithm also requires the following information of reference genome and sequencing data set in advance.
Total length N of the reference genome.
Composition rates of four bases A, C, G and T of the reference genome, and their quadratic sum is marked as ε; the meaning of ε is: randomly and independently sample from the four bases for two times with the composition rates serving as the probability distribution, and ε refers to the probability of obtaining identical bases in the two samplings.
Polymorphism rate γ of this species.
Length L of a sequencing read or the length distribution of all sequencing reads.
Average miscalling error rate β of each base in sequencing; it can be calculated using the base-calling quality value of each base.

The Selection of k₀ and α is to meet the requirement on mapping sensitivity and specificity. Sensitivity here is defined as the probability of a certain sequencing read being mapped to the correct place (where the sequencing read is generated), and specificity is defined as the probability of the sequencing read not being mapped to other places on the reference genome (except for repetitive regions or the homolog regions with high conservative). The selection of k₀, α is described below:

(1) Define the function as below:

$$Ψ ( L , k , θ ) = {\sum }_{g = 0}^{L} [ {\sum }_{w = 1}^{ϕ ( g )} {( - 1 )}^{w - 1} ( \begin{matrix}g + 1 \\ w\end{matrix} ) ( \begin{matrix}L - kw \\ g\end{matrix} ) ] {{θ}^{L - g} ( 1 - θ )}^{g} ,$$

wherein, L represents the length of a sequencing read; k represents the length of the perfect match prefix seed; θ is the match rate of two bases; φ(g) is the smaller value between max{s;L−ks≧g} and (g+1); g is the mismatch number; w is the number of perfect match prefix seeds with lengths of at least k; s is the maximal value that w can reach.

(2) set θ as 1−β−γ, and the sensitivity is calculated as Ψ(L,k,1−β−γ)×(1−α); k* and α are selected to make the sensitivity greater than the given value, such as 99%, 95%, 90%, 80%, etc.

(3) set θ as ε, and the specificity is calculated as: 1−min{NΨ(L,k,ε),1}; k** is selected to make N•(L,k,ε) smaller than a given value, such as 1, 0.5, 0.1, etc.;

(4) If k* is smaller than k**, it is required to adjust the value of a or the requirement on sensitivity and specificity to make k* become greater than k**. When k* is greater than k**, k₀ can be selected as any value in the closed interval [k**, k*].

Above is the method for selecting k₀ and a based on probabilistic model. The parameters can be further optimized through random sampling on the sequencing reads dataset. A detailed implementation is: (1) setting a pair of k₀, α and a sufficiently large U; (2) randomly selecting a certain amount of sequencing reads; (3) for each selected sequencing read, mapping it using the algorithm. If the mapping is successful, record the number of n-mer search; (4) adjusting the value of U based on the distribution of the numbers of n-mer search in (3); (5) performing necessary adjustment for k₀ and a based on the mapping rate.

In step 3 of the above method presented in the present invention, each sequencing read is mapped to the reference genome through the steps of seed anchoring, extension based on auto-match function method and statistical analysis using the said reference genome compression structure, index array and block address array obtained through preprocessing or only using the reference genome compression structure and index array.

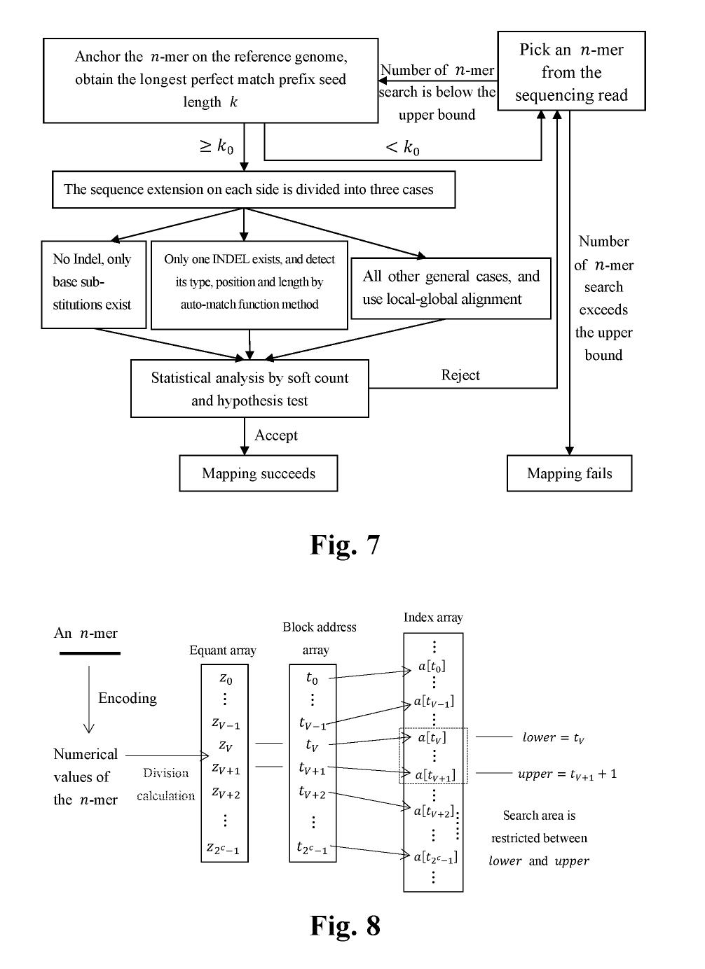

FIG. 7 shows a flow chart of the method of mapping a single sequencing read in the present invention. As is shown in FIG. 7, the method includes:

Step 31: a step of seed anchoring.

If the number of n-mer search is not greater than U, scan the n-mers on the sequencing read sequentially until finding a certain n-mer, which has a prefix with length greater than k₀, and the prefix is perfect match to an equal-length subsequence on the reference genome. The said prefix on the sequencing read is referred as the perfect match prefix seed. The index value of the subsequence on the reference genome is used as the initial anchoring for the sequencing read, and the index value is called as the position on the reference genome corresponding to the perfect match prefix seed. If the number of the subsequences on the reference genome, which have the lengths greater than k₀ and can be perfectly matched to the prefix of the n-mer, is less than G, going to step 32, otherwise, continuing to scan the next n-mer on the sequencing read; if the number of n-mer search is greater than U, it is judged that the mapping is failed, and finishing operation of step 3.

Step 32: a step of extension based on auto-match function method.

No matter whether the quality value of a sequencing read is used or not used, apply the auto-match function method to divide the difference between the fragments on left or right side of perfect match prefix seed on the sequencing read and the fragments on left or right side of the position on reference genome corresponding to the perfect match prefix seed into three cases: (1) only base substitutions exist, namely, only mismatches between the two fragments; (2) only one INDEL exist at one side of perfect match prefix seed, namely, starting from a certain position on the sequencing read fragment, one base, or some continuous bases are inserted or deleted with respect to the fragment on the reference genome; (3) more than one INDEL exist at one side of the perfect match prefix seed. For (1), the detection of difference is already completed; for (2), the auto-match function method is further used to detect the type, position and length of INDEL; for (3), alignment algorithm is used to detect the difference details. In particular, local versus global alignment algorithm is adopted to detect the difference details between extension parts (global) on the sequencing read and the corresponding DNA fragment (local) on the reference genome. On average, the method possesses linear time complexity in terms of the sequencing read length.

Step 33: a step of statistical analysis.

For fragments beyond the perfect match prefix seed on the sequencing read, set a “soft count” for the match status between each base and corresponding base on the reference genome using the polymorphism rate of the species and the base-calling quality values of each base on the sequencing read, and carry on evaluation using probability distribution to determine whether to accept or reject the alignment result between the sequencing read and the reference genome; if the alignment result is accepted, it is judged that the mapping is successful; if not, returning to step 31.

The above step 31 specifically includes the following steps:

Step 311: encode the scanned n-mer on the sequencing read according to the encoding rule determined in step 112 to obtain the numerical value of the n-mer;

Step 312: binary search is initialized, that is to obtain the V-th equant z_{V} based on the numerical value of the n-mer (V is the biggest integer not larger than the quotient obtained by dividing the numerical value of n-mer by 2^{c}) and the V-th element of the block address array t_{V}. Afterwards, set lower, the initiate lower bound, as t_{V}, and set upper, the initiate upper bound, as t_{V+1}+1.

FIG. 8 shows the illustration of the above method of restricting search area using the block address array.

Step 313: perfect match prefix length k of n-mer is set as 0;

Step 314: if upper−lower>1, then go to step 315, otherwise, go to step 318;

Step 315: f is marked as longest common prefix length between S(a[lower+k],n−k) and S(a[upper+k],n−k) and k is reset as k+f;

Step 316: setting

$$middle = ⌊ \frac{lower + upper}{2} ⌋ ,$$

obtaining the numerical value e(S(a[middle+k],n−k)) on the reference genome;

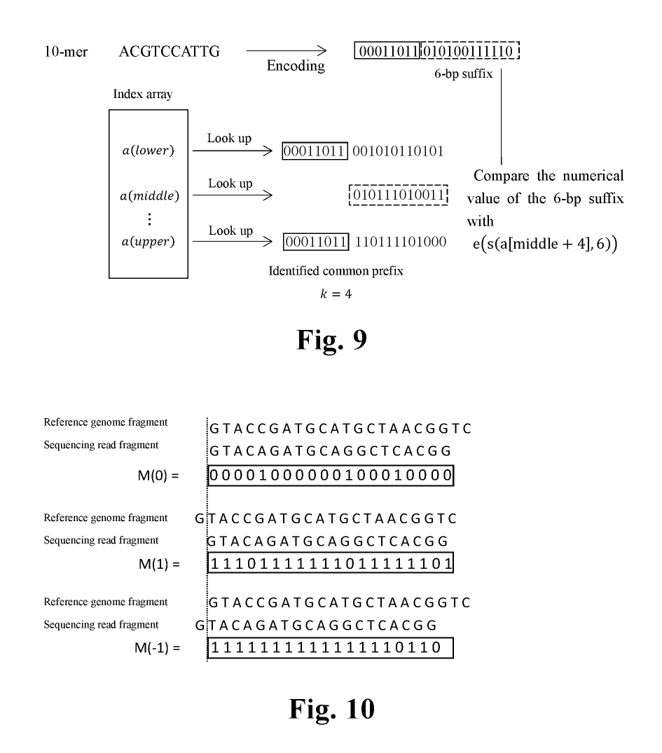

FIG. 9 shows the procedure of the above binary search. As is shown in FIG. 9, wherein, taking n=10 as the example, if the former 8-digits of the two numerical values e(S(a[upper], 10)) and e(S(a[lower], 10)) are same, it indicates that the former 4 bases of corresponding 10-mers are totally identical. Therefore, it only needs to compare e(S(a[middle+4], 6)) with the numerical value of the 6-bp suffix of the 10-mer on the sequencing read.

Step 317: the numerical value of the (n−k)-bp suffix on the said n-mer is compared with the numerical value e(S(a[middle+k],n−k)) obtained from the step 316, and if the numerical value of the (n−k)-bp suffix is greater than or equal to e(S(a[middle+k],n−k)), the lower value is reset as middle and going to the step 314, otherwise, the upper value is reset as middle and going to the step 314.

Step 318: compare S(a[upper+k],n−k) with the (n−k)-bp suffix of the n-mer; denote hᵤ as the length of their longest common prefix and kᵤ as k+hᵤ; compare S(a[lower+k],n−k) with the (n−k)-bp suffix of the n-mer; denote hₗ as the length of their longest common prefix and kₗ as k+hₗ;

Step 319: the longer one of the kₗ-bp prefix and kᵤ-bp prefix on the n-mer is taken as the perfect match prefix seed; if the length of the perfect match prefix seed is less than k₀, then scanning the next n-mer on the sequencing read and returning to step 311; otherwise, obtaining the number of places on the reference genome that the perfect match prefix seed can be anchored, i.e., the number of the subsequences on the reference genome which are identical to the perfect match prefix seed. If the number is greater than G, scanning next n-mer on the sequencing read and returning to the step 311. If the number is smaller than or equal to G, the operation is finished.

The operation procedure of step 32 is described in detail as below based on an example of detecting the difference between the fragment on the right side of the perfect match prefix seed and the reference genome. For the fragment on the left side of the perfect match prefix seed, similar operations can be performed.

Before describing this part, the required notations and variables are introduced at first:

A fragment on the right side of perfect match prefix seed on the sequencing read is marked as X; the length of X is marked as l_{X}; in seed anchoring stage, a subsequence that is identical to the perfect match prefix seed can be found on the reference genome. A fragment with a length greater than l_{X} on right side of this subsequence is marked as Y; the length of Y is marked as l_{Y}. X[i] is marked as the i^{th} base of X and Y[i] is marked as the i^{th} base of Y. When i>0, X{i} is marked as the (l_{X}−i)-bp suffix of X and Y({i} is marked as (l_{Y}−i)-bp suffix of Y. A vector V(X,Y) indicates the match information of all bases when X and Y are aligned at the left. The length of V(X,Y) is the smaller value of l_{X} and l_{Y}. The quality value of X[i] is marked as QA_{X[i]}. The i^{th} element of V(X,Y) is defined as:

Quality value QA_{X[i]} is converted into the miscalling rate β_{X[i]}; if X[i] is same as Y[i], the i^{th} element of V(X,Y) is set as β_{X[i]}, otherwise, it is set as 1−β_{X[i]}.

In the above definition, when quality value QA_{X[i]} is converted into the miscalling rate β_{X[i]}, formula

$${β}_{X [ i ]} = {10}^{- \frac{{QA}_{X [ i ]}}{10}}$$

can be used, and the quality values can also be modified before conversion to obtain more accurate miscalling rates. If the sequencing reads have no quality value information or the quality values have low reliability, the following definition can be adopted: if X[i] is same as Y[i], the i^{th} element of V(X,Y) is set as 0, otherwise, it is set as 1.

M(i) indicates the match vector of X and Y; it is defined as:

M(0)=V(X,Y);

M(i)=V(X,Y{i}), if i>0;

M(i)=V(X{-i},Y), if i<0;

wherein, |i|<min(l_{X},l_{Y}); M(0) indicates mismatch degree of X and Y; if i>0, M(i) indicates the mismatch degree between X and the (l_{Y}−i)-bp suffix of Y; if i<0, M(i) indicates the mismatch degree between Y and the (l_{X}−|i|)-bp suffix of X and Y.

FIG. 10 shows a specific embodiment of the said match vector. Vectors V(X,Y), V(X, Y{1}) and V(X{1}, Y) which are used in the construction of the match vector are defined in the simple way, i.e., the elements thereof only include 0 and 1.

For X and Y, auto-match vector w(i) is defined as below: the j^{th} element of w(i) is the smaller one between the j^{th} element of M(0) and the j^{th} element of M(i). The length of w(i) is the smaller value between the length of M(0) and the length of M(i). Wherein, |i|<min(l_{X}, l_{Y}). AMF(i) is marked as the sum of all elements in the auto-match vector w(i).

Step 32 specifically includes the following steps:

Step 321: if the sum of all the elements in M(0), which is the match vector of the fragments X and Y, is less than h(0≦h≦l_{X}), it is judged that only base substitutions exist between X and Y, and the operation is finished, otherwise, going to step 322; wherein, h is a predetermined value. One preferential method for setting h is setting a test level α₁ at first, and then taking h as the upper α₁ quantile of binomial distribution B(l_{X}, β+γ), or taking h as upper α₁ quantile of Poisson distribution with parameter l_{X}(β+γ), wherein, β is average miscalling rate of the bases on X.

Step 322: the threshold value the of auto-match function is set as m(0≦m≦l_{X}), and AMF(1), AMF(−1), . . . , AMF(B) and AMF(−B) are sequentially compared; B is largest length of the INDEL that can be detected, whose value is preset based on the length distribution of INDELs that exist among different individuals within the species from which the sequencing reads are generated; if an integer j is found satisfying AMF(j)<m, it is judged that X has only one INDEL with respect to Y, stopping comparison and going to step 323, otherwise, it is judged that more complicated differences exist between X and Y, going to step 324; one preferential setting method of the said threshold value m is setting a test level α₂ at first and then taking m as the upper α₂ quantile of binomial distribution B(l_{X}, β+γ), or taking m as the upper α₂ quantile of the Poisson distribution with parameter l_{X}(β+γ), wherein, β is the average miscalling rate of the bases on X.

FIG. 11 shows one specific embodiment of step 322. As is shown in FIG. 11, wherein the sequencing read fragment has a 2-bp deletion with respect to the reference genome fragment. In the example, the threshold value h is taken as 5 and m as 4.

Step 323: if j is a positive number, it is judged that X has a |j|-bp deletion with respect to Y. Otherwise, it is judged that X has a |j|-bp insertion with respect to Y. The start point of the INDEL is detected using the match vectors M(0) and M(j), and the operation is finished;

Step 324: the subtle difference between X and Y is sought using the local versus global alignment algorithm;

The method of using the match vector M(0) and M(j) to detect the start point of the INDEL mentioned in the above step 323 is: subtracting the value of at each position on I_{M(j)}-bp prefix on M(0) by the value at a same position therewith on M(j), wherein I_{M(j)} is the length of vector M(j); for each position on the obtained residual vector, the sum of all elements whose indices are smaller than the position is calculated, and the position corresponding to the minimal summation is judged as the start position of the INDEL. The specific steps are as follows:

Step 3231: the start point P of the INDEL is set as 0, the variables MINI, DIAG and T are set and initialized with 0;

Step 3232: when T<l_{M(j)}, going to step 3233, otherwise, going to step 3236; wherein l_{M(j)} indicates the length of M(j).

Step 3233: DIAG is reset as DIAG+M(0)[T]−M(j)[T], wherein M(0)[T] and M(j) [T] are respectively the T^{th} elements of M(0) and M(j);

Step 3234: if DIAG is smaller than MINI, MINI is reset as DIAG and P is reset as T+1;

Step 3235: T is reset as T+1, returning to step 3232;

Step 3236: if P is 0, it is judged that the start point of the INDEL is located before X[0], otherwise, it is judged that the start point of the INDEL is located after the (P−1)-th base, namely, only the P bases from X[0], . . . , X[P−1] exist before the start point of the INDEL.

FIG. 12 shows one specific embodiment for detecting the start point of the INDEL in the present invention. As is shown in FIG. 12, after comparing the vectors M(0) and M(2), it is obtained that the start point of the 2-bp deletion locates between X[6] and X[7].

In the above step 324, for more complicated occasion, local versus global alignment algorithm is used to detect the differences between X and Y, namely performing alignment between the two fragments. Because X is aligned with Y to the left, but X is longer than Y, the global alignment algorithm is applied on the left ends of the two fragments and the local alignment algorithm is applied on the right ends of the two fragments, namely when initializing the score matrix (namely two-dimensional array F mentioned below), the first row is initialized as the penalty of INDEL and the first column is initialized as 0. In addition, the algorithm can adopt different penalties for different patterns of base substitution, and can also adopt different penalties for different INDEL start points. Step 324 specifically comprises the following steps:

Step 3241: two-dimensional array F[l_{Y}+1][l_{X}+1] is established; F[0][q] is set as δq and F[p][0] is set as 0, wherein, l_{X} is length of X, l_{Y} is length of Y, q≦l_{X}, p≦l_{Y}, and δ is penalty for INDEL, δ<0;

Step 3242: if p≧1 and q≧1, other elements of the two-dimensional array are set based on following formula:

F[p][q]=max{F[p−1][q−1]+θ(X[l_{X}−q],Y[l_{Y}−p]),F[p−1][q]+δ,F[p][q−1]+δ};

wherein θ(X[l_{X}−q], Y[l_{Y}−p]) is the penalty function of the two bases X[l_{X}−q] and Y[l_{Y}−p]; different penalties can be set based on the base-calling quality values and base patterns; for example, when dealing with the methylation data, θ(T,C) can be set as a value close to 0 and θ(C,T) as a value close to −1; in this step, the value of δ can be adjusted based on the values of p and q. The penalties set in this step can be applied to the auto-match function method in step 32; specifically, setting the i^{th} element of vector V(X,Y) as |θ(X[i], Y[i])|, and at the same time, in step 322, replacing the auto-match function value by the sum of the auto-match function value and the absolute value of INDEL penalty, namely replacing AMF(j) by AMF(j)+|jδ|, wherein, j is a nonzero integer, −B≦j≦B.

Step 3243: p is reset as l_{Y} and q is reset as l_{X};

Step 3244: if q>0, going to step 3245, otherwise, the operation is finished;

Step 3245:

If p>0 and F[p][q]=F[p−1][q−1]+θ(X[l_{X}−q], Y[l_{Y}−p]), going to step 3246; if p>0 and F[p][q]=F[p−1][q]+6, going to step 3247; if p≧0 and F[p][q]=F[p][q−1]+δ, going to step 3248;

Step 3246: if X[l_{X}−q] is same as Y[l_{Y}−p], it is judged that X[l_{X}−q] and Y[l_{Y}−p] are matched. Otherwise, it is judged that the both are mismatched; p is reset as p−1 and q is reset as q−1, returning to step 3244;

Step 3247: it is judged that base Y[l_{Y}−p] is deleted in X and p is reset as p−1, returning to step 3244;

Step 3248: it is judged that X[l_{X}−q] is an inserted base with respect to Y, q is reset as q−1, returning to step 3244.

As an alternative option, step 32 can also be implemented as following steps:

Step 32B1: judging whether only base substitutions exist between X and Y using the same method in step 321. If yes, finishing the operation. Otherwise, going to step 32B2;

Step 32B2: sequentially testing the following null hypothesis “X has a single 1-bp deletion with respect to Y, X has a single 1-bp insertion with respect to Y, . . . , X has a single B-bp deletion with respect to Y, X has a single B-bp insertion with respect to Y”; B is the preset maximal length of INDEL that can be detected; if one null hypothesis is accepted, finishing the operation. If all null hypothesis are rejected, going to step 32B3; specifically, when testing a null hypothesis, the method stated in step 323 can be adopted to detect the start point of the INDEL; and then the base substitution sites are obtained; if X[i] is a base substitution site, calculating the soft count as

$$\frac{γ}{{β}_{i} + γ} .$$

Wherein βᵢ is the miscalling rate of X[i] converted from quality value; summing up all the soft counts and setting a test level α₃; if the summation is greater than the upper α₃ quantile of binominal distribution B(l_{X}, γ), or the upper α₃ quantile of Poisson distribution with parameter l_{X}γ, the null hypothesis is rejected; otherwise, the null hypothesis is accepted; when performing the hypothesis tests, the summation of the soft counts can also be replaced by the number of base substitutions.

FIG. 13 shows one embodiment of above step. The embodiment uses base substitution numbers instead of the soft counts. As is shown in FIG. 13, with respect to the reference genome fragment, the sequencing read fragment has a 2-bp deletion. The null hypothesis with respect to “1-bp deletion” and “1-bp insertion” are rejected, because the base substitution numbers are large. While the null hypothesis with respect to “2-bp deletion” is accepted since the base substitution number is 0;

Step 32B3: based on the method stated in step 324, local versus global alignment algorithm is adopted to detect the detailed difference between X and Y;

The above is the method of detecting the difference between the fragment on right side of perfect match prefix seed and the reference genome. For the fragment on left side of perfect match prefix seed and the corresponding fragment on the reference genome, similar method can be adopted. The both can also be completely reversed so as to adopt the method identical to step 32 to detect the difference.

After detecting the differences between fragments at both sides of perfect match prefix seed and the reference genome, these differences are combined to obtain the difference between the whole sequencing read and the reference genome.

Step 33 specifically includes the following steps:

Step 331: estimating the polymorphism rate γ of the species from which the sequencing reads are generated, and calculating the “soft count” for each base outside the perfect match prefix seed on the sequencing read based on its matching status with the reference genome. Specifically, if the i^{th} site on the sequencing read corresponds to a base substitution, the “soft count” is calculated as

$$\frac{γ}{{β}_{i} + γ} .$$

Wherein, βᵢ is miscalling rate of this base converted from quality value and the value is

$${β}_{i} = {10}^{- \frac{{QA}_{i}}{10}} .$$

QAᵢ is the quality value of the i^{th} base on the sequencing read; the quality value can also be modified before conversion so as to obtain more accurate miscalling rate;

Step 332: adding all proportional values

$$\frac{γ}{{β}_{i} + γ}$$

obtained in step 331 and marking the result as sum; if l≧10 and γ≦0.1, pᵥₐₗᵤₑ is taken as the probability of obtaining a value greater than sum when sampling from a Poisson distribution with parameter lγ. Otherwise, pᵥₐₗᵤₑ is taken as the probability of obtaining a value greater than sum when sampling from the binomial distribution B(l,γ); alternatively, pᵥₐₗᵤₑ is taken as the upper quantile of

$$\frac{sum - l γ}{\sqrt{l γ ( 1 - γ )}}$$

about standard normal distribution N(0,1); at the same time, power is taken as upper quantile of sum about binomial distribution B(l,1−ε); if pᵥₐₗᵤₑ≧α, it is judged to accept the alignment result; otherwise, it is judged to reject the alignment result; wherein, l is obtained by subtracting the perfect match prefix seed length from the read length, and α is the test level taken in step 2.

Since the sequencing read can be generated from either the forward strand or the reverse complementary strand of the reference genome, it is necessary to map the reverse complementary sequence of the sequencing read if the original read fails to be mapped. The said reverse complementary sequence read of the sequencing read is obtained by replacing each base on the sequencing read by its complementary paired base therewith and then reversing all the bases from left to right.

After a round of mapping, parameters are adjusted based on mapping speed, proportion of successfully mapped sequencing reads and the distribution of sensitivity and specificity of the successfully mapped sequencing reads; then the sequencing reads that fail to be mapped or with poor sensitivity and specificity are re-mapped using the method stated in step 3.

Step 5 is the output step, the mapping information of each sequencing read is output and all the information is written into files with standard format. For each sequencing read, the output mapping information comprises the following contents:
a) Name of the sequencing read in the data set, and it is indicated as an integer or a character string;
b) Whether the sequencing read is successfully mapped; it is indicated as an integer or a character string; information of failed mapping is obtained in step 31 and information of successful mapping is obtained from in 33;
c) Name of the reference genome to which sequencing read is mapped, and it is indicated as a character string;
d) Position of the sequencing read on the reference genome, and it is obtained in step 32 and indicated as an integer;
e) Base substitution, insertion and deletion between the sequencing read and the reference genome, and they are obtained in step 32 and indicated as a character string;
f) Base composition of the sequencing read, and it is indicated as a character string; g) Quality value information of each base on the sequencing read, and it is indicated as a character string;
h) Perfect match prefix seed length k;
i) Mapping sensitivity Ψ(L, k, 1−β−γ)×(1−pᵥₐₗᵤₑ), and it is obtained in step 33;
j) Mapping specificity 1−min{NΨ(L,k,ε)×(1−power),1}, and it is obtained in step 33;
   Compared with step 2, k in the expressions of sensitivity and specificity is the length of the perfect match prefix seed found when step 31 finishes, and in the expression of sensitivity, pᵥₐₗᵤₑ obtained in step 332 is used to replace the test level α. In the expression of specificity expression, NΨ(L,k,ε) is replaced by NΨ(L,k,ε)×(1−power). The said standard format is: for sequencing reads that are successfully mapped, mapping information is output according to the order from a) to j); for that sequencing reads that are not successfully mapped, only a), b), f) and g) are output.

For the mapping of methylation sequencing reads, under the same frame as the above method, several modifications are needed.

1. In the preprocessing stage, the generation method of reference genome compression structure is unchanged. However, in the step 121 of generating index array, a difference coding scheme can be adopted:

Code A: also using two digits to represent each base with C and T being identically encoded. For example, encoding A and G respectively with 00, 01, and encoding C or T with 10;

Code B: adopting Huffman code; for example, encoding A and G respectively with 00, 01, and encoding C or T with 1. At this time, four bases have different code-lengths, 1 or 2.

When generating the index array, for the non-methylation occasion, all n-mers are encoded with 2n-digit binary codes. For the methylation occasion, 2n-digit binary codes are still used to encode the subsequences on the genome. If Code A is adopted, every segment of 2n-digits still correspond to a n-mer. If Code B is adopted, the corresponding subsequences thereof may be different in length. The length can be any integer in the closed interval [n, 2n], which depends on C/T content. Other steps such as sorting or element storage operations keep unchanged. However, for the methylation occasion, it is required to generate the index array for both the forward strand and the reverse complementary strand of the reference genome.

2. In the parameter design stage, specificity is calculated according to the composition rates of the three nucleotide letters A, G, C/T.

3. In seed anchoring stage, corresponding changes for step 311 is required. 2n-digit binary code is still used to encode the subsequence starting from each position on sequencing reads. However, the coding scheme must be same as the on adopted when generating the index array. If Code A is adopted, the length of the subsequence encoded with the 2n-digit binary codes is n. If Code B is adopted, the length of subsequence encoded with the 2n-digit binary codes can be any integer in the closed interval [n, 2n].

At the same time, when obtaining a numerical value from the reference genome compression structure, it is required to convert the binary code taken from the reference genome compression structure, which corresponds to a subsequence on the reference genome, according to the coding scheme used for generating the index array, so as to obtain the numerical value of the subsequence.

4. In the extension stage, an auto-match function method is used at first to divide the difference between the sequencing read and the reference genome into three cases: (1) only base substitutions exist; (2) only one INDEL exist at one side of the perfect match prefix seed; (3) more than one INDEL exist at one side of the perfect match prefix seed; during operations, C and T are identically encoded, namely, considering C and T as an identical base. For case (2), the type, position and length of the potential INDEL is further detected using the auto-match function method with C and T being respectively encoded, namely, considering C and T as different bases. For case (3), the detailed difference is detected using a local versus global alignment algorithm, and at this time, C and T are encoded differently and a count system applicable to methylation data is adopted. Specially, a local versus global alignment algorithm is adopted to detect the detailed difference between extension part (global) of sequencing read and corresponding DNA fragment (local) on the reference genome.

5. If the sequencing read is failed to be mapped to the forward strand of the reference genome, it is still required to map the sequencing read to the reverse complementary strand of reference genome, and at this time, the index array of the reverse complementary strand is used. The obtaining of the said reverse complementary strand is as follows: replacing each base of the forward strand of the reference genome by the complementary paired base therewith, and performing left and right reversing on the obtained strand to obtain the reverse complementary strand.

To implement the system, a combination of software and hardware is adopted. The system is mainly divided into three links, namely preprocessing, seed anchoring and extension based on auto-match function method. Given a reference genome, the preprocessing is performed only once and the result is maintained in the storage system, which is used for different sequencing data set repeatedly. Quick sort or heap sort algorithm is adopted to sort 2n-digit binary codes.

The seed anchoring and extension stages, which are computationally intensive, can be implemented through the method below.

1. They are implemented based on the software written in C++ and other programming languages.

2. One or more CPUs are adopted for serial or parallel calculation in mapping.

3. In seed anchoring, the index array, reference genome compression structure and block address array are required. However, in real works, data are only read from these structures and the three structures will not be modified once generated. High performance storage hardware can be adopted to store the three structures in a common storage space.

4. When a subsequence on reference genome is taken out, it is required to be aligned with the sequencing read in the extension stage based on auto-match function method. However, during the aligning procedure, it is not required to read data from the common storage space. Furthermore, the auto-match function method and the local versus global alignment algorithm are only performing alignment between the two character strings, and the program is very simple. In the extension stage, GPU can be adopted to implement high performance parallel computation.

5. Like the FPGA biological computation system (Timelogic, DeCypher) which is similar to the Smith-Waterman algorithm, FPGA or programmable DSP is adopted for solidification in core algorithm.

Above method can be implemented in the combination of software and hardware, comprising: parallel computing is implemented by more than one CPU in the seeding stage; parallel computing is implemented by GPUs in the extension stage; and adopting DSP and FPGA technology in the core algorithm.

The present invention also discloses a system of mapping sequencing reads, which operates on a reference genome and at least one sequencing read; wherein the reference genome is a genome which has already been sequenced; and the system comprises:

a reference genome preprocessing module, which is configured to perform preprocessing for the said reference genome to generate a reference genome compression structure, an index array and a block address array; wherein the said reference genome compression structure stores the whole reference genome in a compressive way; the said index array stores the index values of all sorted n-mers on the said reference genome; and the said block address array is configured to store the positions of a portion of elements in the index array, aiming at accelerating the anchoring of a sequencing read on the reference genome;

a parameter design module, which is configured to design the parameters for a mapping algorithm according to probabilistic calculation, based on the characteristics of the reference genome, the information of all the sequencing reads as a whole, genetic differences between the reference genome and the species from which the sequencing reads are generated, to meet or compromise the requirements on sensitivity, specificity and mapping speed;

a mapping module, which is configured to map each sequencing read to the said reference genome through the steps of seed anchoring, extension based on auto-match function method, and statistical analysis, based on the above said reference genome compression structure, index array and block address array obtained through preprocessing;

a result outputting module, which is configured to output the mapping information of each sequencing read and write all the output information into files with standard formats.

All the above various modules can be implemented by software, hardware or a combination of software and hardware.

The above method and system presented in the present invention possess the following features:

1. When constructing index array in the preprocessing stage, index values of all sorted n-mers on a reference genome are stored, but the values of the n-mers themselves on the reference genome are not stored directly. In this way, storage space can be reduced;

2. Selecting an encoding rule is based on the difference between sorted numerical values and uniform distribution; block address array can be adopted to accelerate the binary search;

3. In the preprocessing stage, unsigned integers with different lengths can be adopted according to the length of the reference genome to implement flexible storage for the index array;

4. In the seed anchoring stage, the block address array is used to reduce the search area; during binary search, the length of common prefix of known upper and lower bounds is no longer investigated to accelerate the searching speed;

5. In the seed anchoring stage, perfect match prefix seeds with variable lengths can be found, which is more flexible than the searching method based on hash tables;

6. In the extension stage, time complexity of the auto-match function method is linear with respect to the sequence length. If the auto-match function method is failed, an local versus global alignment algorithm can find the exact optimal alignment;

7. Both seed anchoring stage and extension stage based on the auto-match function method are provided with statistical analysis; the result is evaluated to guarantee mapping sensitivity (sequencing reads can be mapped onto reference genome) and specificity (sequencing reads shall not be mapped to inaccurate place); statistical analysis can guide parameter design and thus making the operation more flexible;

8. Preprocessing and mapping speeds are faster than existing tools, and mapping rate is generally higher than existing tools. The method can be implemented on generic computer servers and workstations.

9. For methylation data, Huffman encoding or other encoding is used to encode A, G, C and T. When mapping methylation data, corresponding adjustment is performed for penalty among base categories in the auto-match function algorithm, and the local versus global alignment algorithm, etc.;

10. The method can be implemented by a system in a combination of software and hardware according to different demands and available hardware equipment, comprising: parallel computing is implemented by more than one CPU in the seeding stage; parallel computing is implemented by GPUs in the extension stage; and adopting DSP and FPGA technology in the core algorithm;

11. It is observed from the working experiences that the method has faster preprocessing and mapping speeds than existing tools, generally higher mapping rate than existing tool. Therefore, it is applicable to generic computer servers and workstations and is capable of completing mapping work with only a standalone computer server or workstation at a processing speed several times faster than the cluster server, thereby greatly reducing maintenance cost and improving operation flexibility (within same time, parameter can be adjusted to perform mapping for several times).

Generally speaking, the computation system presented in the present invention possesses the following functions:

1. Re-sequencing reads are mapped at a high speed;

2. For given data characteristics, such as reading length, quality value and a group of system parameter values, mapping sensitivity and specificity can be evaluated;

3. For specific biological and medical problem, based on given data characteristics, such as read length and quality value, system parameter values are designed to reach reasonable mapping sensitivity and specificity. In case of any margin, mapping speed can also be optimized through parameter design;

4. The system is modularized;

5. For different modules, different hardware and software are used for the implementation. Hardware can be a combination of generic CPU, RAM and hard disk memory, such as workstations, server. The hardware can also comprise GPU, FPGA (reconfigurable computation unit), DSP, etc.

The above solution presented in the present invention is applicable to biological analysis as well as qualitative and quantitative measurement for DNA hereditary information and functional RNA information in personalized medicine, comprising qualitative and quantitative measurement of DNA polymorphism, methylation, messenger RNA expression profile, non-coding RNA abundance, ChIP-seq and alternative splicing information

The embodiments mentioned above further describe the purposes, technical solutions and beneficial effects of present invention. It should be understood that what is described above is only embodiments of the present invention, and is not intended to limit the present invention. Any modification, equivalent replacement, improvement, etc. made within the spirit and principle of the present invention shall be included within the protection range of the present invention.

1. A method of mapping sequencing reads, which performs operations for an obtained reference genome and at least one sequencing read, wherein the reference genome is a genome sequence whose sequencing has been completed, and the operations comprise the following steps:
Step 1: performing preprocessing for the said reference genome to generate a reference genome compression structure, an index array and a block address array; wherein the said reference genome compression structure stores the whole reference genome in a compressive way; the said index array stores the index values of all sorted n-mers on the said reference genome; and the said block address array is configured to store the positions of a portion of elements in the index array, aiming at accelerating the anchoring of a sequencing read on the reference genome;
Step 2: based on characteristics of the reference genome, information of all the sequencing reads as a whole, genetic differences between the reference and the species from which the sequencing reads are generated, designing parameters of a mapping algorithm according to a probability calculation to meet or to compromise the requirements on sensitivity, specificity and mapping speed;
Step 3: based on the above said reference genome compression structure, index array and block address array obtained from the preprocessing, mapping each sequencing read to the said reference genome through the steps of seed anchoring, extension based on an auto-match function method and statistical analysis;
Step 4: outputting the mapping information of each sequencing read.

2. The method of mapping sequencing reads according to claim 1, wherein,
when generating the reference genome compression structure and the index array in Step 1, the nucleotide letters in the set {A, C, G, T} are encoded by the two-digit in the set {00, 01, 10, 11} under a certain rule; wherein, for the mapping of non-methylation sequencing reads data, the said encoding means:
a one-to-one correspondence between elements of the said nucleotide letter set {A, C, G, T} and the elements of the two-digit set {00, 01, 10, 11}.

3. The method of mapping sequencing reads according to claim 2, wherein, an optimal encoding is determined through the following steps:
Step 11: under each encoding from the nucleotide letter set {A, C, G, T} to the two-digit set {00, 01, 10, 11}, converting each n-mer on the reference genome into a binary integer, that is, the numerical value of the n-mer, wherein n is a preset length value;
Step 12: sorting the numerical values of all n-mers under the said each encoding in the ascending order, and selecting the encoding that results in the numerical values of all n-mers whose distribution best fits the uniform distribution as the optimal encoding.

4. The method of mapping sequencing reads according to claim 1, wherein, the reference genome compression structure in Step 1 is generated as below:
using an encoding to store the reference genome base by base into a vector of the byte type, either in the left to right direction or in the right to left direction, with each byte storing four bases.

5. The method of mapping sequencing reads according to claim 1, wherein, the index array in Step 1 is generated as below:
for each n-mer on the reference genome, obtaining its numerical value according to an encoding, and sorting the numerical values of all n-mers in the ascending order; wherein the index values all sorted n-mers on the reference genome form the said index array; and wherein, n is a preset length.

6. The method of mapping sequencing reads according to claim 1, wherein, the block address array in Step 1 is generated as below:
for an equant zᵢ=i×2^{2n-c}, i=0, 1, 2 . . . , 2^{c}−1 in the interval [0,4ⁿ−1], using binary search on the numerical values of all sorted n-mers on the reference genome as pointed by the index array, and find two neighboring elements a[tⁱ] and a[tᵢ+1] in the index array such that equant zᵢ is between the two numerical values of the n-mers starting respectively at a[tᵢ] and a[tᵢ+1] on the reference genome, and the address value tᵢ in the index array is taken as the i^{th} value of the block address array; wherein, c is a preset integer value and its value range is 1≦c≦2n, and n is the preset length.

7. The method of mapping sequencing reads according to claim 1, wherein, the parameters described in Step 2 comprises the lower bound of the perfect match prefix seed length k₀ and the test level α; the length n in the n-mer used in constructing the index array in Step 1 is greater than k₀; k₀ and the test level α are selected to meet the requirements on mapping sensitivity and specificity; parameters selection depends on the length, polymorphism rate and base composition rate of the said reference genome, the read length and base-calling quality values of the said sequencing reads; the selection of parameters is carried out through probabilistic calculations.

8. The method of mapping sequencing reads according to claim 1, wherein, mapping sequencing reads to the reference genome in Step 3 specifically comprises:
Step 31: for a sequencing read, using the said reference genome compression structure, index array and block address array generated in Step 1 or only using two structures, namely the reference genome compression structure and the index array, to search the perfect match prefix seed between each n-mer of the sequencing read and each n-mer of the reference genome until a perfect match prefix seed whose length is greater than the lower bound k₀ is found, and going to Step 32; otherwise, judging that the sequencing read fails to be mapped; wherein, the said perfect match prefix seed is a prefix of the said n-mer which is perfectly matched to the prefix of the corresponding n-mer on the said reference genome;
Step 32: for a found perfect match prefix seed, according to the applicability of the auto-match function method, to divide the relationships between the nucleotide fragments on left and right sides of the said perfect match prefix seed in the sequencing read and their counterpart fragments respectively on the left and right sides of the perfect match positions on the reference genome, into three cases: (1) only base substitutions exist; (2) only one INDEL exist at one side of the perfect match prefix seed; (3) more than one INDEL exist at one side of the perfect match prefix seed; wherein, regarding the case (2), the type, position and length of the potential INDEL is further detected using the auto-match function method; regarding the case (3), the detailed difference is detected using a local versus global alignment algorithm;
Step 33: for the parts beyond the perfect match prefix seed on the sequencing read including its left-side and right-side fragments, using a binomial distribution, or a Poisson distribution, or a normal distribution to evaluate the goodness of matching of all bases with respect to the reference genome to determine whether to accept or reject the alignment result between the sequencing read and the reference genome; the base-calling quality values and the genetic difference between the reference genome and the genome of the target species are used in the evaluation; if the alignment result is accepted, judging that the mapping is successful; if not, returning to Step 31 to search a new perfect match prefix seed.

9. The method of mapping sequencing reads according to claim 8, wherein, Step 31 specifically includes:
Step 311: obtaining the numerical value of an n-mer on the sequencing read based on an encoding;
Step 312: after equally dividing the interval [0, 4ⁿ−1] into 2^{c} parts and sorting the resulting 2^{c} equants in the ascending order, obtaining two adjacent equants, denoted by the V-th and (V+1)-th equants, through computation so that the numerical value obtained in Step 311 is larger than or equal to the V-th equant which is the smaller one, and strictly smaller than the (V+1)-th equant which is the larger one;
Step 313: taking the value of the V-th element in the block address array as the lower bound of search area denoted by lower, taking the value of the (V+1)-th element in the block address array plus 1 as upper bound of search area denoted by upper, and setting the perfect match prefix seed length k as 0;
Step 314: obtaining the two n-mers on the reference genome that start from the indices corresponding to the lower bound and upper bound of search area, namely, the locations of the two n-mers on the reference genome are respectively the values of the said lower-th and upper-th elements in the index array, and obtaining f, the length of the longest common prefix between the (n−k)-bp suffix of the two n-mers; updating the perfect match prefix seed length k by k+f;
Step 315: obtaining the n-mer on the reference genome that starts from the index corresponding to the middle point of the search area, namely, from the integer closest to the average of the values of the lower-th and upper-th elements in the index array, and comparing the numerical value of its (n−k)-bp suffix with the numerical value of the (n−k)-bp suffix of the n-mer on the sequencing read; if the latter is larger than or equal to the former one, updating the lower bound of search area by the middle point, otherwise updating the upper bound of search area by the middle point; the said middle point is array a position in the index array like the said lower and upper, and it is the integer closest to the average of the said lower and upper;
Step 316: repeating Steps 314 to 315 until the difference between the upper bound and the lower bound of the search area is smaller than or equal to 1; obtaining the n-mer on the reference genome that starts from the index corresponding to the lower bound of the search area, and comparing its (n−k)-bp suffix with the (n−k)-bp suffix of the n-mer on the sequencing read; adding the length of the longest common prefix of the two suffix to k and defining the sum as the first length; obtaining the n-mer on the reference genome that starts from the index corresponding to the upper bound of the search area, and comparing its (n−k)-bp suffix with the (n−k)-bp suffix of the n-mer on the sequencing read; adding the length of the longest common prefix of the two suffixes to k and defining the sum as the second length;
Step 317: if the larger value between the said first length and second length is greater than k₀, the prefix of the n-mer on the sequencing with length as the said larger value is the perfect match prefix seed;
Step 318: if the number of positions on reference genome that can be anchored by the perfect match prefix seed exceeds a predetermined value G, turning to Step 311 to do the anchoring for the next n-mer on the sequencing read.

10. The method of mapping sequencing reads according to claim 8, wherein, in Step 32, the procedure of detecting the difference between fragment to the left of the said perfect match prefix seed on the sequencing read and the corresponding fragment on the reference genome is similar to the procedure of detecting the difference between fragment to the right of the perfect match prefix seed on the sequencing read and the corresponding fragment on the reference genome, wherein the procedure of detecting the difference between the fragments on the right specifically comprises:
Step 321: acquiring the fragment X on the right side of the perfect match prefix seed on the said sequencing read, and acquiring the fragment Y on the right side of the position corresponding to the said perfect match prefix seed on the reference genome; l_{Y}, the length of Y, is greater than l_{X}, the length of X;
Step 322: if the sum of all elements in the match vector M(0), a measure of goodness of match between X and Y, is less than a predetermined value h, judging that the difference between X and Y only comprises base substitutions, and finishing the operation; otherwise, turning to step 323; wherein, each element of M(0) represents the matching degree of the corresponding base on X and the corresponding base on Y, 0≦h≦l_{X}, and l_{X} is the length of the fragment X;
Step 323: sequentially comparing AMF(1), AMF(−1), . . . , AMF(B), AMF(−B) with a preset threshold m, wherein B is a largest length of INDEL that can be detected; if a certain integerj makes AMF(j)<m, going to Step 324; otherwise, turning to Step 325;
Step 324: if j is a positive number, judging that X has a |j|-bp deletion with respect to Y; otherwise, judging that X has a |j|-bp insertion with respect to Y; detecting the start point of the INDEL, and finishing the operation;
Step 325, using the local versus global alignment algorithm to detect the differences between X and Y;
wherein, M(0)=V(X,Y); if i>0, then M(i)=V(X, Y{i}), Y{i} is the (l_{Y}−i)-bp suffix of Y; if i<0, then M(i)=V(X{−i}, Y), X{−i} is the (l_{X}−|i|)-bp suffix of X; the length of V(X,Y) is the smaller value of l_{X} and l_{Y}; elements of V(X,Y) have two definitions: (I) if the i^{th} base of X equals that of Y, the i^{th} element of V(X,Y) is βᵢ; otherwise, the i^{th} element is 1−βᵢ; wherein βᵢ is the miscalling rate obtained from the base-calling quality value of the i^{th} base of fragment X; (II) if the i^{th} base of X equals to the i^{th} base of Y, the i^{th} element of V(X,Y) is 0; otherwise, it is 1;
AMF(i) is the sum of all elements in the auto-match vector w(i), wherein the auto-match vector w(i) is defined as below: the k^{th} element of w(i) is the smaller value of the k^{th} element of M(0) and the k^{th} element of M(i); wherein the length of w(i) is the smaller value between the lengths of M(0) and M(i); and i is an integer with its absolute value smaller than the smaller value of the lengths of M(0) and M(i).

11. The method of mapping sequencing reads according to claim 10, wherein, Step 324 specifically comprises:
For M(j) obtained in Step 323, subtracting the value at each position on the l_{M(j)}-bp prefix of M(0) by the value at the same position therewith on M(j), wherein l_{M(j)} is the length of M(j), and the resulting residual vector is of length l_{M(j)}; for each position on the obtained residual vector, calculating the partial sum of the elements from the first position up to the said current position; and judging the position corresponding to the minimum partial sum as the starting position of the INDEL on X.

12. The method of mapping sequencing reads according to claim 10, wherein, Step 325 specifically comprises:
Step 3251: establishing a two-dimensional array F[l_{Y}+1][l_{X}+1]; setting F[0][q] as δq and F[p][0] as 0, wherein, l_{X} is the length of X, l_{Y} is the length of Y, q≦l_{X}, p≦l_{Y}, δ is the preset penalty for INDEL, and δ<0;
Step 3252: for p≧1 and q≧1, setting other elements of two-dimensional array based on the following recursive scheme:
F[p][q]=max{F[p−1][q−1]+θ(X[l_{X}−q],Y[l_{Y}−p]),F[p−1][q]+δ,F[p][q−1]+δ};
wherein θ(X[l_{X}−q],Y[l_{Y}−p]) is the score function of the matching status of X[l_{X}−q] and Y[l_{Y}−p]; the INDEL penalty δ in this step can change with the specific values of p and q;
Step 3253: resetting p as l_{Y} and q as l_{X},
Step 3254: if q>0, going to step 3255; otherwise, finishing the operation;
Step 3255: if p>0 and F[p][q]=F[p−1][q−1]+θ(X[l_{X}−q], Y[l_{Y}−p]), going to step 3256; if p>0 and F[p][q]=F[p−1][q]+δ, going to Step 3257; if p≧0 and F[p][q]=F[p][q−1]+δ, going to step 3258;
Step 3256: if X[l_{X}−q] and Y[l_{Y}−p] are the same, judging that X[l_{X}−q] is matched with Y[l_{Y}−p]; otherwise, judging that they are mismatched; resetting p as p−1 and q as q−1, and returning to Step 3254;
Step 3257: judging that base Y[l_{Y}−p] is deleted in X, and resetting p as p−1, and returning to Step 3254;
Step 3258: judging that X[l_{X}−q] is an inserted base with respect to Y, and resetting q as q−1, and returning to Step 3254.

13. The method of mapping sequencing reads according to claim 12, wherein, the score or penalty θ and δ applied in Steps 3251 and 3252 can be applied to Step 32, wherein, the i^{th} element of vector V(X,Y) can be set as |θ(X[i], Y[i]), and in Step 323, replacing the auto-match function value by the sum of the auto-match function value and the absolute value of INDEL penalty, namely replacing AMF(j) by AMF(j)+|jδ|; wherein j is a nonzero integer, and −B≦j≦B.

14. The method of mapping sequencing reads according to claim 8, wherein, Step 32 is implemented through the following steps:
Step 321: judging whether only base substitutions exist between the fragments X and Y; if yes, finishing the operation; otherwise, turning to Step 322;
Step 322: for every possible INDEL pattern whose length is no larger than B, detecting the start point thereof, obtaining the alignment result and evaluating the alignment result, wherein if the alignment result is accepted, finishing the operation; otherwise, performing alignment and evaluation for the next possible INDEL pattern; wherein B is the preset largest length of INDEL that can be detected;
Step 323, if alignment results for all INDEL patterns are rejected, using the local versus global alignment method to align X and Y.

15. The method of mapping sequencing reads according to claim 8, wherein, Step 33 specifically comprises:
Step 331: acquiring a polymorphism rate γ of the species from which the sequencing reads are generated, and if the i^{th} base of a sequencing read is mismatched with the corresponding nucleotide base on the said reference genome, calculating the proportion
$$\frac{γ}{{β}_{i} + γ}$$
for the i^{th} base on the sequencing read, wherein, βᵢ is the miscalling probability obtained from the base-calling quality value, namely, the phred score;
Step 332: taking sum as the summation of all the proportion values
$$\frac{γ}{{β}_{i} + γ} ,$$
calculating the upper quantile of sum based on the binomial distribution B(l,γ) or the Poisson distribution with parameter lγ, or calculating the upper quantile of
$$\frac{sum - l γ}{\sqrt{l γ ( 1 - γ )}}$$
using a standard normal distribution N(0,1); if the upper quantile is not smaller than a, accepting the alignment result between the sequencing read and the reference genome; otherwise, rejecting the alignment result between the sequencing read and the reference genome; and wherein, l is obtained by subtracting the perfect match prefix seed length from sequencing read length, and the test level α is the one set in Step 2.

16. The method of mapping sequencing reads according to claim 1, wherein, before performing Step 4 also comprising: for the sequencing reads that have not been mapped successfully or the sequencing reads with poor mapping status in terms of sensitivity or specificity, they are re-mapped after adjusting the mapping parameters; and the output of mapping information in Step 4 specifically comprises: names of all sequencing reads in a data set, the mapping status, success or failure, of all sequencing reads, the name of a reference genome to which a sequencing read is mapped, the position of each mapped sequencing read on the reference genome, the difference between a sequencing read and its counterpart on the reference genome, the nucleotide sequence of a sequencing read, base-calling quality value of each base on the sequencing read, the perfect match prefix seed length, sensitivity and specificity of mapping.

17. The method of mapping sequencing reads according to claim 1, wherein, for the mapping of methylation sequencing reads, the encoding used in generating the reference genome compression structure is the same as the non-methylation case; and when generating the index array, the following encoding is adopted:
Code A: using two digits to represent each nucleotide letter of {A, G, C, T} with C and T being identically encoded;
Code B: adopting a Huffman coding scheme; encoding C or T with a single and identical digit; encoding A and G respectively with two-digit binary numbers; wherein, the second digits used to encode A and G are different, while the first digits thereof are the same, which are different from the binary digit encoding C or T;
for the mapping of a methylation sequencing read, it is required to generate two index arrays, one for the forward strand and one for the reverse complementary strand of the reference genome; furthermore, when mapping the methylation sequencing reads in Step 3, the sequencing reads are mapped to both of the forward and reverse complementary strand of the reference genome.

18. The method of mapping sequencing reads according to claim 1, wherein, the method is applicable to qualitative or quantitative measurements of DNA hereditary information and RNA functional information in biological analysis and personalized medicine, comprising qualitative or quantitative measurements of DNA polymorphisms, methylation, messenger RNA expression profiles, non-coding RNA abundances, ChIP-seq, alternative splicing information.

19. The method of mapping sequencing reads according to claim 1, wherein, parallel computing is implemented by more than one CPU in the seeding part, namely, Step 31; and parallel computing is implemented by GPUs in the extension part, namely, Step 32.

20. The method of mapping sequencing reads according to claim 1, wherein, the method is implemented by software or a combination of software and hardware.

21. A system of mapping sequencing reads, which operates on a reference genome and at least one sequencing read; wherein the reference genome is a genome which has already been sequenced; and the system comprises:
a reference genome preprocessing module, which is configured to perform preprocessing for the said reference genome to generate a reference genome compression structure, an index array and a block address array; wherein the said reference genome compression structure stores the whole reference genome in a compressive way; the said index array stores the index values of all sorted n-mers on the said reference genome; and the said block address array is configured to store the positions of a portion of elements in the index array, aiming at accelerating the anchoring of a sequencing read on the reference genome;
a parameter design module, which is configured to design a mapping algorithm parameters according to probability calculations, based on the characteristics of the reference genome, the information of all the sequencing reads as a whole, genetic differences between the reference genome and the species from which the sequencing reads are generated, to meet or to compromise the requirements on sensitivity, specificity and mapping speed;
a mapping module, which is configured to map each sequencing read to the said reference genome through the steps of seed anchoring, extension based on the said auto-match function method, and the said statistical analysis, based on the above said reference genome compression structure, index array and block address array obtained through preprocessing;
a result outputting module, which is configured to output mapping information of each sequencing read.

22. The system of mapping sequencing reads according to claim 21, wherein, parallel computing is implemented by more than one CPU in the seeding part, namely, Step 31; and parallel computing is implemented by GPUs in the extension part, namely, Step 32.

23. The system of mapping sequencing reads according to claim 21, wherein, the above modules are implemented by software or a combination of software and hardware.
